(19) United States
(12) Patent Application Publication
(10) Pub. No.: US 2025/0026237 A1
(43) Pub. Date: Jan. 23, 2025

(54) CHARGE RESERVOIR

(71) Applicant: PowerFlex Systems, LLC, San Diego, CA (US)

(72) Inventor: Kellock IRVIN, San Francisco, CA (US)

(21) Appl. No.: 18/760,774

(22) Filed: Jul. 1, 2024

Related U.S. Application Data
(60) Provisional application No. 63/515,105, filed on Jul. 23, 2023.

(51) Int. Cl. B60L 58/12; B60L 53/30; B60L 53/62

(52) U.S. Cl. CPC B60L 58/12; B60L 53/305; B60L 53/62

(57) ABSTRACT

Certain aspects of the present disclosure provide techniques for providing a charge reservoir. Some embodiments of a method include determining that a first electric vehicle (EV) is coupled to a first electric vehicle supply equipment (EVSE) and a second EV is coupled to a second EVSE, determining a current state of charge and a desired charge for the first EV and the second EV, and determining that the first EV has a current state of charge that is greater than the desired charge. Some embodiments include determining that the second EV has a current state of charge that is less than the desired charge, utilizing the first EVSE to remove charge from the first EV to a charge reservoir and utilizing by the computing device, the second EVSE to transfer charge from the charge reservoir to the second EV until the desired charge for the second EV is met.

### CROSS REFERENCE

This application claims the benefit of U.S. Provisional Application Ser. No. 63/515,105, filed Jul. 23, 2023, entitled Charge Reservoir, which is hereby incorporated by reference in its entirety.

### INTRODUCTION

Aspects of the present disclosure relate to providing a charge reservoir for a plurality of electric vehicles (EVs) and other electric devices to access in charging.

### BACKGROUND

Increased popularity of electric vehicles (EVs) has led to an increased need for charging stations or electric vehicle supply equipment (EVSE), especially in urban areas. Some charging sites may utilize a large number of EVSE to facilitate the charging of many plugged-in EVs; however, it is often the case that not all plugged-in EVs can be charged at once owing to limitations of the electrical infrastructure. Additionally, as energy costs and demand for charging increases, the availability of adequate energy to charge the EVs may fail to meet the demand.

As such, many of these charging stations load share the charging capacity between the plugged-in EVs during times of peak charging demand. While load sharing may alleviate some supply and user experience concerns, there still exists energy shortages that reduce user experience in charging reduce the ability to receive the expected charge on the expected timeline.

Thus, a need exists in the industry for systems and methods to address the deficiencies of charge that many current charging stations are able to provide as well as to optimize charging events such that an EV can receive its expected charge on its expected timeline.

### SUMMARY

Certain aspects of the present disclosure provide techniques for providing a charge reservoir. Some embodiments of a method include determining that a first electric vehicle (EV) is coupled to a first electric vehicle supply equipment (EVSE) and a second EV is coupled to a second EVSE, determining a current state of charge and a desired charge for the first EV and the second EV, and determining that the first EV has a current state of charge that is greater than the desired charge. Some embodiments include determining that the second EV has a current state of charge that is less than the desired charge, utilizing the first EVSE to remove charge from the first EV to a charge reservoir and utilizing by the computing device, the second EVSE to transfer charge from the charge reservoir to the second EV until the desired charge for the second EV is met.

One embodiment of a system includes a charging station that includes a first electric vehicle supply equipment (EVSE) for receiving a first electric vehicle (EV) and a second EVSE for receiving a second EV and an edge environment that is coupled to the charging station. The edge environment may include a memory component and a processor. The edge environment may include an edge cluster that, when executed by the processor, causes the system to determine that the first EV is coupled to a first EVSE and the second EV is coupled to the second EVSE, determine a current state of charge and a desired charge for the first EV and the second EV, and determine that the first EV has a current state of charge that is greater than the desired charge. In some embodiments, the edge environment causes the system to determine that the second EV has a current state of charge that is less than the desired charge, utilize the first EVSE to remove charge from the first EV to a charge reservoir, and utilize the second EVSE to transfer charge from the charge reservoir to the second EV until the desired charge for the second EV is met.

One embodiment of a non-transitory computer-readable storage medium includes logic, that, when executed by a computing device, causes the computing device to determine that a first electric vehicle (EV) is coupled to a first electric vehicle supply equipment (EVSE) and a second EV is coupled to a second EVSE, determine a current state of charge and a desired charge for the first EV and the second EV, and determine that the first EV has a current state of charge that is greater than the desired charge. In some embodiments, the logic causes the computing device to determine that the second EV has a current state of charge that is less than the desired charge, utilize the first EVSE to remove charge from the first EV to a charge reservoir, and utilize the second EVSE to transfer charge from the charge reservoir to the second EV until the desired charge for the second EV is met.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 depicts a computing environment for providing a charge reservoir, according to embodiments provided herein.

FIG. 2 depicts a software configuration for edge environment, according to embodiments provided herein.

FIGS. 3A-3C depict example hardware configurations for the edge environment, according to embodiments provided herein.

FIGS. 4A-4C depict hardware that may be utilized for the devices from FIGS. 3A-3C, according to embodiments provided herein.

FIG. 5A depicts a configuration of EVSE for charging a plurality of vehicles, according to embodiments provided herein.

FIG. 5B depicts another configuration of EVSE that uses load sharing logic for scheduling EV charging over a period of time, according to embodiments provided herein;

FIG. 5C depicts another configuration of EVSE that uses a charge reservoir for EV charging, according to embodiments provided herein.

FIG. 6 depicts a configuration of EVs to opt-in or opt out of participating in a charge reservoir, according to embodiments provided herein.

FIG. 7 depicts a flowchart for providing a charge reservoir, according to embodiments provided herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Embodiments disclosed herein include systems and methods for providing a charge reservoir. A charge reservoir may be a reservoir of power that is pooled from EVs instead of the electrical grid. Some embodiments are configured to determine if a user and/or EV has opted into participating in the charge reservoir. Users and/or EVs that have opted into the charge reservoir, may communicate, for example, current state of charge, desired charge, a departure time, and/or maximum charge to a charge controller, which may be deployed into an edge environment. When plugged into an EVSE at a charging station, a determination may be made regarding whether the EV needs charging or whether the EV can contribute at least a portion of its charge to the charge reservoir. Similarly, a vehicle that is below the desired state of charge could charge to the maximum state of charge at a time of day when the facility is not constrained, and discharge it later (when the site is constrained) to a second vehicle that is in need. As referred to hercin, an EVSE is a bi-directional EVSE that is configured to charge an EV and receive charge from the EV for other electrical draws. EVSEs may also draw power from sites or other buildings with a utility meter. An EV is a vehicle that uses electrical energy for power and thus includes an energy storage device, such as a battery. The charge reservoir may be configured as a physical and/or virtual component and may thus allocate charge to those EVs that, based on, for example, current charge state, desired charge state, and departure time, and other consideration, need to begin charging. Similarly, some embodiments are configured to consider cost of charging to allow users to utilize the charge reservoir during high cost periods, thereby reducing charging costs. Some embodiments may compensate users who contribute charge to the charge reservoir, based on a predetermined compensation model. Still some embodiments may be configured to provide a mechanism for peer to peer charging via the charge reservoir.

### Example Environment

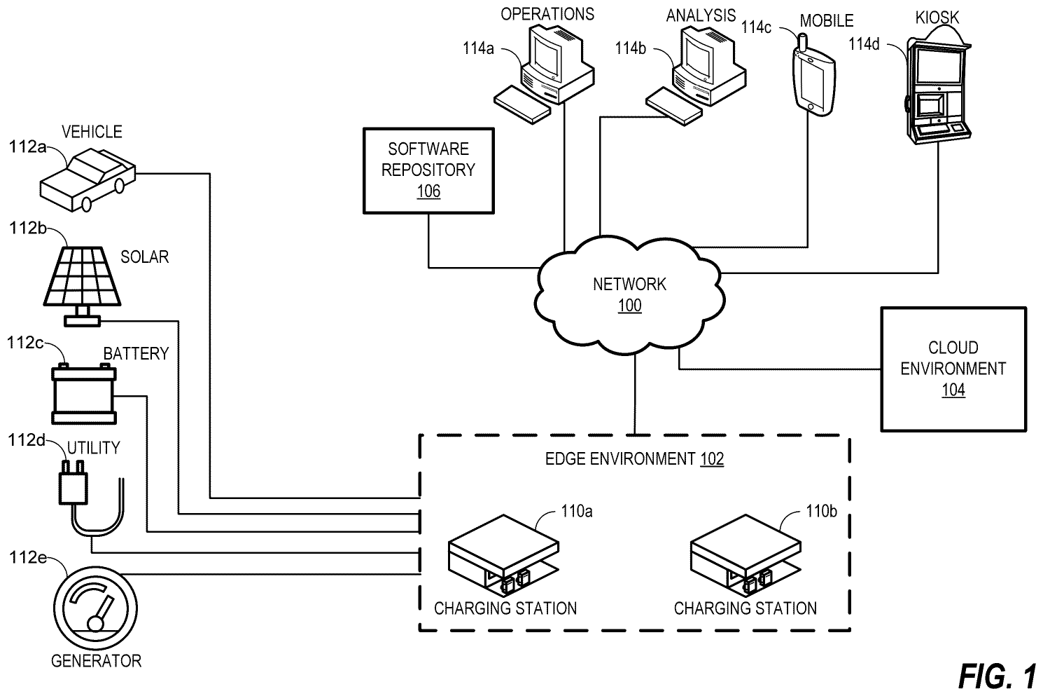

FIG. 1 depicts a computing environment for providing a charge reservoir, according to embodiments provided herein. As illustrated, the computing environment includes a network 100 that is coupled to an edge environment 102, a cloud environment 104, and a software repository 106. The network 100 may be configured as any wide area network (WAN, such as the internet, power network, cellular network, etc.), local network (e.g., LAN, Ethernet, Wireless-Fidelity, etc.).

The edge environment 102 may include and/or be coupled with one or more charging stations 110, such as charging station 110a, each of which may include one or more EVSE. The charging station 110a may be configured to charge one or more electric vehicles (EV) and/or other electric devices. The charging station 110a may utilize any protocol of charging, communication, and/or control such as open smart charging protocol (OSCP), open charge point interface (OCPI), ISO 15118, OpenADR, etc. and may represent Level 1, Level 2, Level 3, and higher powered charging stations, as applicable.

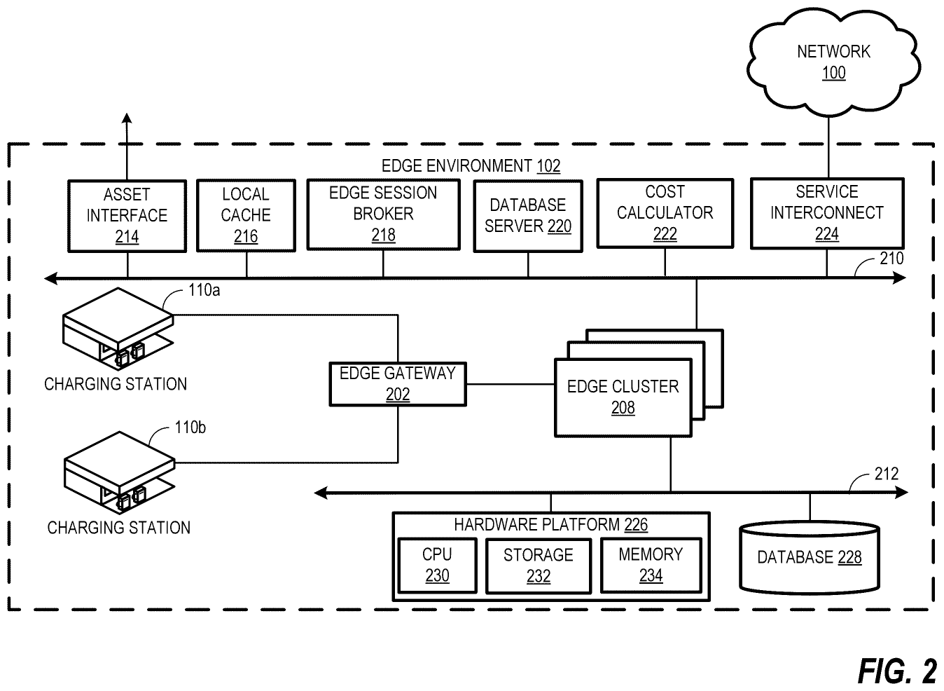

As described with reference to FIG. 2, the edge environment 102 may be configured as an interface between the charging stations 110 and the network 100. Some embodiments may be configured such that the computing power at one or more of the charging stations 110 may be controlled dynamically (e.g., increased or decreased, limited, etc.) and the edge environment 102 may be configured to provide fast processing of data, as well as processing when access to the network 100 may be limited or unavailable.

The cloud environment 104 may be coupled to the edge environment 102 via the network 100 and may be configured for further processing of data, as described herein. While FIG. 1 depicts a single cloud environment 104 that serves a single edge environment 102, this is merely an example, as some embodiments may be configured such that the cloud environment 104 may serve a plurality of edge environments 102 that each serve one or more charging stations 110 and/or one or more energy sources 112.

Also coupled to the edge environment 102 are energy sources 112. The energy sources 112 may include a vehicle 112a, a solar device 112b, a battery 112c, a utility 112d (such as a coal plant, solar plant, wind farm, electrical grid, etc., which is a traditional reservoir of energy from where a site pulls to power buildings, EVSEs, and other electrical equipment), a generator 112e, and/or other sources of energy. While not an exhaustive list, the energy sources 112 may provide energy to the charging stations 110. In some embodiments, the charging stations 110 may send excess energy back to vehicle 112a, battery 112c, and/or to the utility 112d. Regardless, the edge environment 102 may monitor and/or modify the energy received from the energy sources 112 to be properly utilized by the corresponding charging station 110.

Also coupled to the network 100 is a software repository 106. The software repository 106 may be configured as a platform to program, store, manage, control changes, etc. to software that is implemented in the edge environment 102 and/or cloud environment 104. The software repository 106 may be configured as a proprietary service and/or may be provided by a third party, such as GitHub™.

Also depicted in FIG. 1 are ancillary devices 114. The ancillary devices 114 may include an operations device 114a, an analysis device 114b, a mobile device 114c, a kiosk 114d, and/or other devices. Specifically, the operations device 114a may be utilized to monitor and/or alter operations of the computing environment provided in FIG. 1. The analysis device 114b may analyze utilization, operation, charging, and/or other features of the computing environment. The mobile device 114c may represent an administrator device and/or a user device. As a user device, the mobile device 114c may initiate charging, payment, and/or perform other user-specific actions. As an administrator device, the mobile device 114c may perform administrative operations, analysis, and/or perform other actions. The kiosk 114d may be located at one of the charging stations 110 and/or remote therefrom and may provide user-specific or administrative actions, similar to that of the mobile device 114c. As will be understood, the ancillary devices 114 may each include a processor, a memory component, and/or other hardware and/or software for preforming the functionality provided herein.

### Example Aspects of an Edge Environment

FIG. 2 depicts a software configuration for edge environment 102, according to embodiments provided herein. As illustrated, the edge environment 102 may be coupled to the charging stations 110 via an edge gateway 202. Also included in the edge environment 102 is an edge cluster 208, which is coupled to communication bus 210 and hardware bus 212. The communication bus 210 may be coupled to an asset interface 214, a local cache 216, an edge session broker 218, a database server 220, a cost calculator 222, and a service interconnect 224. Similarly, the hardware bus 212 may be coupled to a hardware platform 226, which may include a processor, such as CPU 230, storage component 232, memory component 234, and/or other hardware components. Also coupled to hardware bus 212 is a database 228. Communication bus 210 provides a mechanism for all services that run on the edge and communicate with each other via a distributed message streaming system. The coupling of these aforementioned services 208-228 is accomplished via a distributed message streaming protocol such as NATS.

The charging stations 110a, 110b may represent any type of charging station (such as level 2, open charge point protocol (OCPP), etc.) and may be configured for serial bus communication, communication via a peer-to-peer communication protocol, such as Zigbee, and/or other wired or wireless communication protocol. Depending on the particular embodiment, the charging station 110a may represent a charging station of a first protocol and the charging station 110b may represent a charging station of a different protocol. The charging stations 110 may each include a plurality of charging bays with respective EVSE for receiving EVs to charge. Through use of the edge environment 102, the charging stations 110 may be configured to dynamically allocate charge to one or more of the EVSE, based on demand. Specifically, some embodiments may be configured such that the charging stations 110 include more charging bays than can be utilized simultaneously. As such, if the number of EVs (and specifically the charge demands of those EVs) exceeds maximum output of the charging stations 110, embodiments may be configured to dynamically schedule charging of each of the EVs, based on charge requests so that the EVs receive the requested energy by the time requested.

The edge gateway 202 may be configured to receive data, such as electric charging data, price charge data, vehicle data, etc. from the charging stations 110 and/or vehicles that are being charged. Additionally, the edge gateway 202 may be configured to abstract data received from the charging stations 110 to remove protocol specific distinctions. Thus, data output from the edge gateway 202 may be a protocol relative to the protocol of data utilized by the particular charging stations 110. The edge gateway 202 may send the data to the edge cluster 208.

The edge cluster 208 may be the central message center in various embodiments. For example, when a user plugs a vehicle into a charging station 110, the edge cluster 208 receives data from the edge gateway 202, parses that data to access state data, and causes the state data to be sent to the database server 220. The edge cluster 208 also receives the data and creates a session entry, which may be stored in the local cache 216. The edge cluster 208 may additionally send the session entry to the cloud environment 104. The edge session broker 218 may also receive data related to the new session and will reach out to the database server 220 to access additional session data and solves for a charge curve. Additionally, the edge cluster 208 may include and/or have access to load sharing logic, which may provide an awareness of driver needs and behavior and shift electrical loads between EVs, as well as cause the edge environment 102 to schedule charging across various EVSE. As an example, if the number of EVs that are plugged in at the charging station 110 causes the charge demand to exceed the supply that the charging station 110 can provide, the load sharing logic may cause the edge environment 102 to schedule charge provided to each EV, based on the requested energy and the available time.

The edge session broker 218 may produce data or signals that are sent to the edge cluster 208, which may be sent to the edge gateway 202 for potentially sending back to one or more of the charging stations 110. Information that may be reported might include current delivered over time (e.g., amperes), total energy delivered (e.g., kWh), power delivered over time (e.g., kW), voltage at the charging station 110 over time (e.g., V), charging station state (e.g., connected, disconnect, offline), alarms and/or messages about a state of the charging stations 110, information about the vehicle, such as state of charge (a measure (0-100%) of how much energy a vehicle has to operate), payment processing, etc. The charging stations 110 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy sources 112.

It should be understood that the edge cluster 208 is configured such that any message received by the edge cluster 208 may also be sent to the cloud environment 104, for example, data related to whether a user (or driver) has opted into the charge reservoir functionality. Thus, if a user of the mobile device 114c (FIG. 1) desires to claim a session and use the charge reservoir capabilities, the mobile device 114c does not need to access the edge environment 102 directly. Instead, the mobile device 114c may connect with the cloud environment 104, which sends a message to the edge cluster 208 with an instruction to claim the session. As will be understood, the service interconnect 224 may be configured for establishing an HTTP, TCP, and/or other type of communication with the cloud environment 104 via the network 100.

Additionally, the hardware platform 226 represents any hardware for facilitating the processes and actions described herein. Specifically, the CPU 230 may be configured as any processor for executing instructions received from the hardware platform 226. The storage component 232 may be configured as long term storage, such as a hard drive or the like. The memory component 234 may include any of various types or read access memory or the like. The database 228 may be configured for additional storage and may be housed with the other hardware and/or elsewhere.

It should be understood that the components and/or services of FIG. 2 may be implemented in logic, such as software, firmware, and/or hardware, as described herein. Accordingly, non-transitory computer-readable storage medium, such as the storage component 232, the memory component 234, and/or the database 228 may be utilized for storing the logic for execution.

### Example Hardware Configurations for Edge Environment

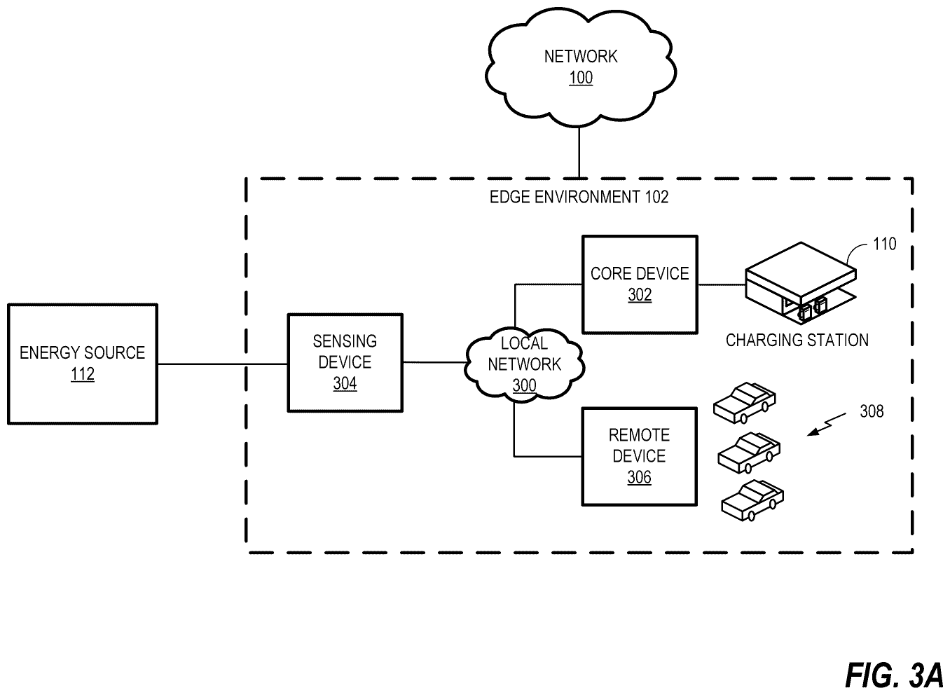

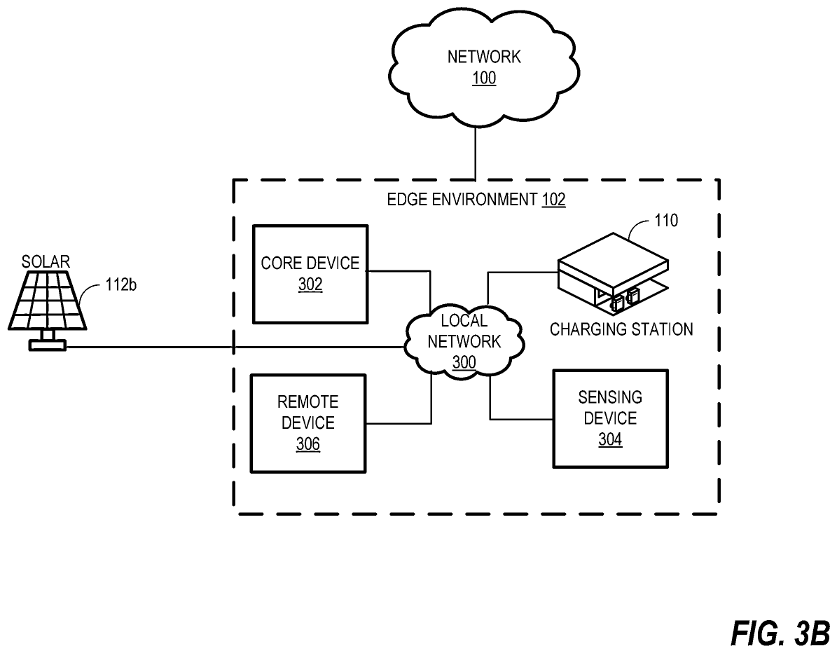

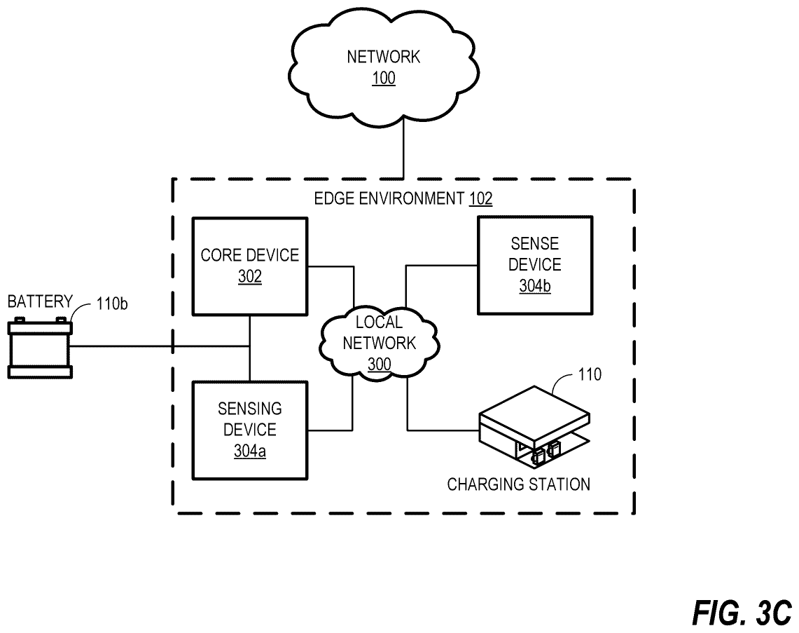

In the embodiment of FIG. 3A, the core device 302 is the central processing device and serves as the communications hub. The core device 302 may provide optimization, load management, communication coordination, and data historian services. The core device 302 communicates with the cloud environment 104 either via cellular modem, or wired internet service provider (ISP) 104 to get the latest optimization and load management set points for charging stations 110 and other assets. As such, the core device 302 dispatches these set points, through a local communications protocol (e.g., Wi-Fi) and/or via the remote device 306 to reach locations that are distant or hard to reach, such as charging stations 110 for EVs 308 at sub-levels of a parking garage or a rooftop solar inverter. The core device 302 additionally collects data directly from the energy sources 112 or through cloud-based communications with the network 100.

FIGS. 3A-3C depict example hardware configurations for the edge environment 102, according to embodiments provided herein. Specifically, FIG. 3A depicts a charging solution. As illustrated, the charging station 110 is coupled to a local network 300 via core device 302. The local network 300 may include any local area network, Ethernet, personal access network, etc., as described above with reference to the network 100 from FIG. 1. The core device 302 may be physically installed within communications range of the chargers in the charging station 110. A sensing device 304 may be installed, for example, in an electrical room or in another enclosure with electrical equipment of the charging station 110 and/or one or more energy sources 112 to monitor the main metering point for the local utility point of common coupling. This enables algorithms to provide the optimal dispatch of EV charging power, subject to local energy rates and the vehicles currently charging. In the case that there are EVs 308 using EV chargers that are out of communications range of the core device 302, such as a sub-level of a parking garage, a remote device 306 are included as required.

Power and energy metering data may be collected via the sensing device 304. The sensing device 304 may include a smart meter with support for multiple single-and three-phase loads with a local historian and Ethernet communication back to the device via the local network 300. The sensing device may also incorporate support for additional devices running on the edge including but not limited to thermocouple wiring, weather stations, temperature sensors, pyranometers, etc. It should be noted that additional sensing devices 304 and remote devices 306 can be added to handle variable situations, such as a separate subpanel for energy metering of a new solar or for monitoring of a new inverter associated with a rooftop solar installation.

FIG. 3B depicts a solar application where the core device 302 and the sensing device 304 are installed in the facility's electrical room or other common area. The sensing device 304 can monitor the main metering point for the local utility as well as the solar production at tie-in breakers for the solar device 112b. The remote device 306 may be installed in a position to communicate directly with the solar device 112b and report the data received from the solar device 112b to the core device 302. Accordingly, the core device 302, the sensing device 304, and the remote device 306 depicted in FIG. 3B may perform similar functions as those devices depicted in FIG. 3A.

FIG. 3C depicts a battery application where the core device 302 and the sensing device 304 are physically installed near a battery 112c storage installation. In cases where the battery 112cis near the point of common coupling with the utility 112d, a single sensing device 304a can monitor the full site. In cases where there is a significant distance to the metering point for the utility 112d, a second sensing device 304b (or a plurality of sensing devices 304b) may be installed near the utility meter, such as the electrical room.

### Example Hardware components in Core, Sense, and Remote

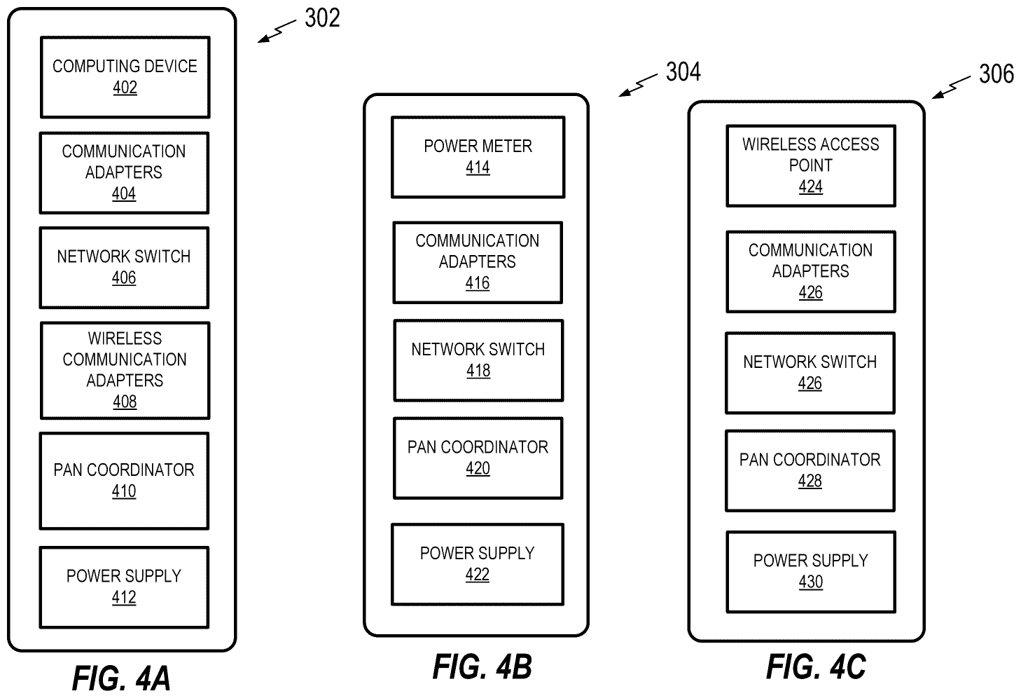

FIGS. 4A-4C depict hardware that may be utilized for the devices from FIGS. 3A-3C, according to embodiments provided herein. Specifically, FIG. 4A depicts hardware components that may be present in a core device 302. In some embodiments, the core device 302 is the brain where the energy optimization and adaptive load management functions are executed and dispatched. As illustrated, the core device 302 may include a computing device 402, a communication adapter 404 (or more than one), a network switch 406, a wireless communication adapter 408, a PAN coordinator 410, and a power supply 412. As will be understood, the computing device 402 may include a processor, memory, and/or other components that a normal, specific purpose machine may utilize. In some embodiments, the computing device 402 may include powerline communication (PLC) infrastructure, while some embodiments may utilize retail and/or micro-industrial computer components for optimization, load management, communication coordination, and/or historian services.

The communication adapter 404 may be configured for load balancing and otherwise managing communications and may be configured, for example, as an Modubus RTU (RS485) to Modbus TCP (Ethernet) or Ethernet IP (RJ45) to Ethernet Optical (SFP), etc. The network switch 406 may be configured for routing of network traffic, and may be configured as an Ethernet switch for communication to other nodes (e.g., the sensing device 304, the remote device 306, and/or other core device 302), distributed energy resources, and/or energy based management systems.

The wireless communication adapter 408 may include a cellular modem, internet modem, Wi-Fi access point, etc. for facilitating wireless communications to the internet or other wide area network. Similarly, the PAN coordinator 410 may be configured to create and/or join communication connections with other devices. This may include a Zigbee™ coordinator, Bluetooth™ device, and/or other device for performing this function. The power supply 412 may be configured as a battery power, connection to external power, etc.

FIG. 4B depicts hardware components of the sensing device 304 from FIGS. 3A-3C. The sensing device 304 may be configured as a smart-metering piece for collection and storage of power/energy data including but not limited to measurements such as temperature, voltage, current, power, solar irradiance, wind speed, etc. The sensing device 304 may include a smart meter with multiple channels of measurement that may comprise single-phase circuits and/or three-phase circuits. The sensing device 304 may communicate meter data back to the core device 302 from meter locations such as electrical rooms, rooftop solar installations, EV chargers, and subpanels. These embodiments may be optimized for ease of installation and reduced intrusion to the site. Power over Ethernet (POE) sourced from the core device 302 suffices for most installations. The sensing device 304 may transmit data back to the core device 302 via a network switch. The sensing device 304 is optimized to utilize minimal power and PoE is acceptable for most installations.

As illustrated in FIG. 4B, the sensing device 304 includes a power meter 414, a communication adapter 416, a network switch 418, and may include a PAN coordinator 420, and a power supply 422. The power supply 422 may include a power interface for providing power to the sensing device 304. The power meter 414 may be utilized for monitoring single-phase and three-phase loads of power. The communication adapter 416 may be utilized for facilitating communications between the sensing device 304 and other devices. The network switch 418 may be a PoE enabled switch for communication. Similarly, the PAN coordinator 410 may create and/or join personal area networks, such as via Zigbee™, Bluetooth™, and the like.

As illustrated in FIG. 4C, the remote device 306 is a network-connectivity extension, primarily for EV charging or solar monitoring locations where ZigbeeTM, Wi-Fi, or Ethernet is being extended to remote or difficult-to-reach locations such as remote subpanels, parking garage levels, or rooftop inverters. Some embodiments are optimized for ease of installation and reduced intrusion to the site where PoE suffices for most installations from the core device 302. The remote device 306 may be configured to transmit data back to the core device 302 via the network switch 406.

Specifically, the remote device 306 may include a wireless access point 424, a communication adapter 426, a network switch 428, and may include a PAN coordinator 430, and a power supply 432. The wireless access point 424 may be configured to extend wireless communication signals to chargers and/or other intelligent electronic devices. The communication adapter 426 may be configured for facilitating communications between the remote device 306 and other devices. The network switch 428 may be configured as a PoE Ethernet switch and/or other network switch for communicating with the core device 302. The PAN coordinator 430 may be configured to create and/or join personal area networks, such as via Zigbee™, Bluetooth™, and the like. The power supply 432 may include a power interface for providing power to the sensing device 304.

### Example Use Cases

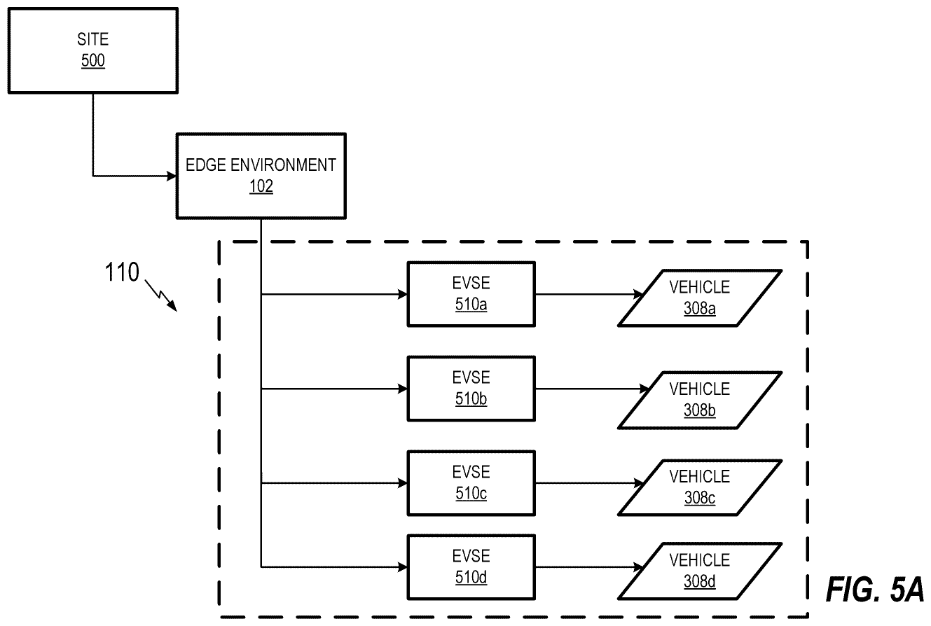

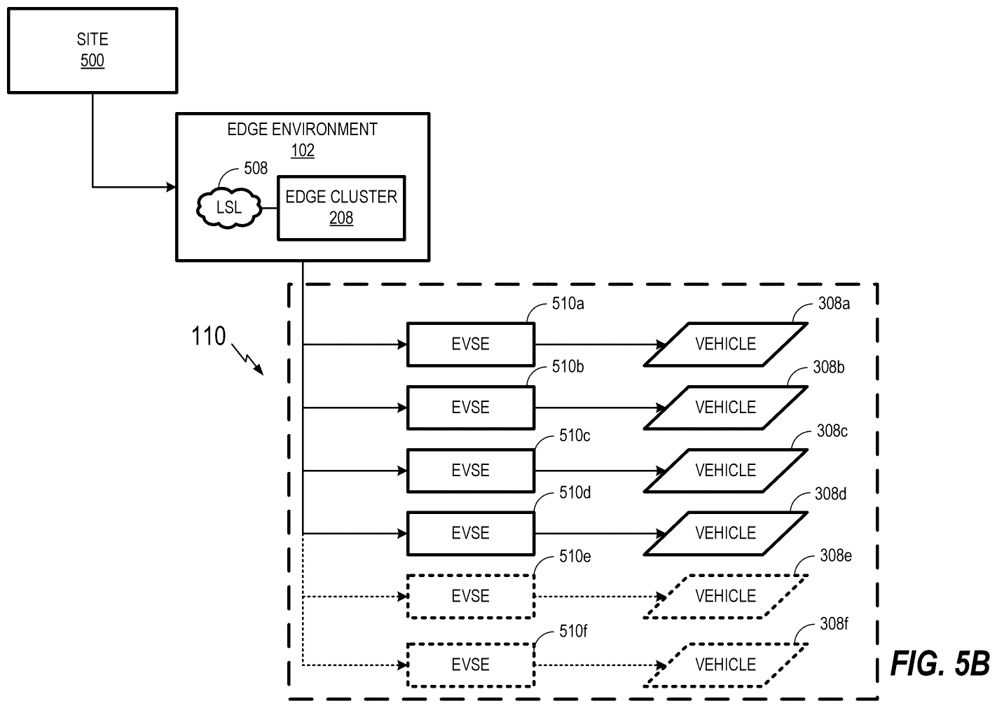

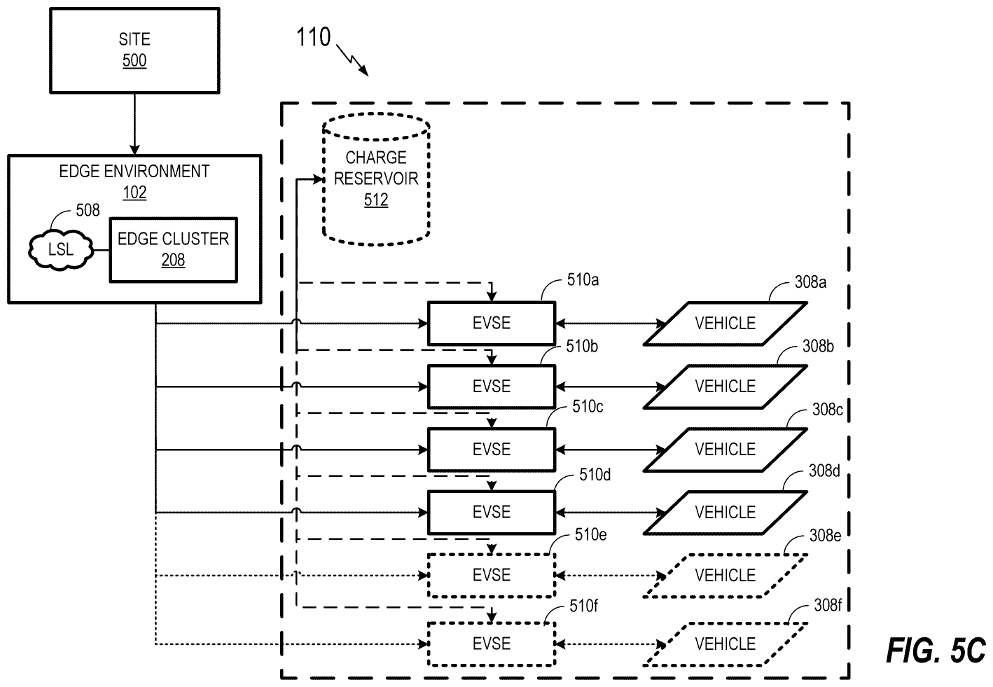

FIG. 5A depicts a configuration of EVSEs 510a, 510b, 510c, 510d for charging a plurality of EVs, according to embodiments provided herein. As illustrated, the site 500 may provide energy to a charging station 110. In some embodiments, the charging station 110 may additionally receive data from the site 500. Similarly, some embodiments may be configured to send the energy and/or data to the edge environment 102. The edge environment 102 may then provide energy to one or more of EVSEs 510a, 510b, 510c, 510d (collectively EVSEs 510), which then provide the energy to the respective EVs 308a, 308b, 308c, 308d (collectively EVs 308). While this configuration is useful when the charging station 110 has enough energy capacity for each of the EVSEs, problems may result if the supply of energy is outpaced by demand.

FIG. 5B depicts another configuration of EVSEs that uses load sharing logic for scheduling EV charging over a period of time, according to embodiments provided herein. As illustrated, the utility 112d may provide energy to the charging station 110 and/or edge environment 102. Additionally, the edge environment 102 may include and/or be coupled with load sharing logic 508. As such, embodiments provided herein may be configured to accommodate additional EVs 308e, 308f (via EVSEs 510e, 510f), even though the maximum energy output from the charging station 110 cannot meet the demands of the additional EVs 308e, 308f. Specifically, the load sharing logic 508 may cause the edge environment 102 to schedule charging of the EVs 308 in a manner that allows the charging station 112 to provide the desired amount of energy to each of the EVs 308 in the desired time specified for each of the EVs 308. As an example, a user may send a session request to the charging station 110 that the EV 308a needs 40 kWh in over an 8-hour period. The user of EV 308b may indicate to the charging station that EV 308b needs 40 kWh over two hours. As EV 308a has more time to charge, the load balancing logic may cause the charging station 110 to prioritize EV 308b because there is a shorter amount of time to charge EV 308b.

FIG. 5C depicts another configuration of EVSEs that uses a charge reservoir for EV charging, according to embodiments provided herein. As illustrated in this example, the site 500 may provide energy and/or data to the edge environment 102. The edge environment 102 may provide the energy and/or data to the charging station 110, which is then distributed to the EVs 308a-308f via the EVSEs 510a-510f, respectively.

However, the embodiment of FIG. 5C utilizes a charge reservoir 512. The charge reservoir 512 represents a storage mechanism for energy and may be virtual and/or physical. Specifically, embodiments of EVSEs 510 may be configured to provide energy to respective EVs 308 or pull energy from the EVs 308 (providing a bidirectional flow of energy), based on needs of the remaining EVs. When the charge reservoir 512 is a physical component (such as a battery), the load management logic 508 may cause the edge environment 102 to receive a request for energy, which may include a time for departure from at least one of the EVs 308. Additionally, the edge environment 102 may determine the current charge status, a minimum charge, a maximum charge, etc. of each of the EVs 308. If one or more of the EVs 308 has excess charge, the edge environment 102 may cause the respective EVSE 510 to extract energy from that EV 308 and store that energy in the charge reservoir 512. If the charge reservoir 512 is a virtual component, the edge environment 102 may allocate the excess charge from a particular EV for use when needed and/or may transfer that charge to another EV 308 that will be plugged into the EVSE for longer. As an example, if EV 308c has 80% charge, but only needs 20% for its departure in 8 hours, the edge environment 102 may allocate 60% for use by another EV 308d because it is determined that when EV 308c needs to begin charging again, the grid will be using an off-peak pricing structure. The EVSE 510c may extract the 60% and communicate to the EVSE 510d for providing to the EV 308d. Similarly, if EV 308c has 40% charge, but is not expected to leave for several hours, the load sharing logic 508 may utilize the excess charge capacity of EV 308c as a portion of a virtual charge reservoir. Depending on the charge capacity and/or time of departure, a plurality of the EVs 308 may be utilized for this purpose.

It will be understood that embodiments provided herein may receive an indication of the next physical destination and/or the amount of charge needed to reach that destination for the user and/or EV 308. Some embodiments may be configured to receive user input regarding the desired charge level and/or range the user desires to have when leaving the charging station 110. It will also be understood that embodiments may be configured to compensate users with credit, payment, and/or other incentives for participating in the charge reservoir 512 program and/or for actually allowing charge to be removed from the user's vehicle 308.

Some embodiments may utilize this feature to increase cost savings. As an example, it is possible that the charging station 110 may actually have capacity to charge each of the EVs, but the demand charges for energy may be at its highest based on time of use or similar pricing schemes. Demand charges are a utility pricing mechanism that charges sites more money per kilowatt, the more power is requested from the electrical grid. As such, the edge environment may use charge from one (or more) EV 308e for charging another (one or more) EV 308, such that when the price returns to a more tolerable level, charging of the EVs from the utility 112d may resume.

It will be understood that when the charge reservoir 512 is a physical component, some embodiments may be configured to maintain a predetermined level of charge in the charge reservoir 512 to be ready for use at any time. Some embodiments may additionally be configured to incentivize users to contribute to the charge reservoir 512 through reduced costs of charging, priority charging, etc. When the charge reservoir operates as a virtual component, embodiments may be configured to allow users to share energy peer-to-peer through use of the charge reservoir. In these embodiments, a user may instruct (e.g., via a mobile application, vehicle interface, etc.) the edge environment to provide a predetermined amount of energy from the user's EV 308 to another user's EV 308. This may occur when both EVs 308 are coupled to respective EVSEs 510 and/or may be performed at different points in time, such that the donor EV 308 provides the energy to the charge reservoir 512, which stores the energy until the receiver EV 308 arrives to receive the energy or is otherwise ready to receive energy.

Accordingly, in embodiments where the charge reservoir 512 is a virtual component, the edge environment 102 may be configured to utilize other EVs 308 that are coupled to the charging station 110 as energy storage devices. In these embodiments, the edge environment 102 may transfer charge to a first EV 308 for storage until the receiver EV 308 couples to the charging station 110. If the first EV 308 needs to leave before the receiver EV 308 arrives, charge may be transferred to a second EV 308. In some embodiments, a virtual charge reservoir and a physical charge reservoir may be utilized.

### Example Configuration for Opting-In to Charge Reservoir

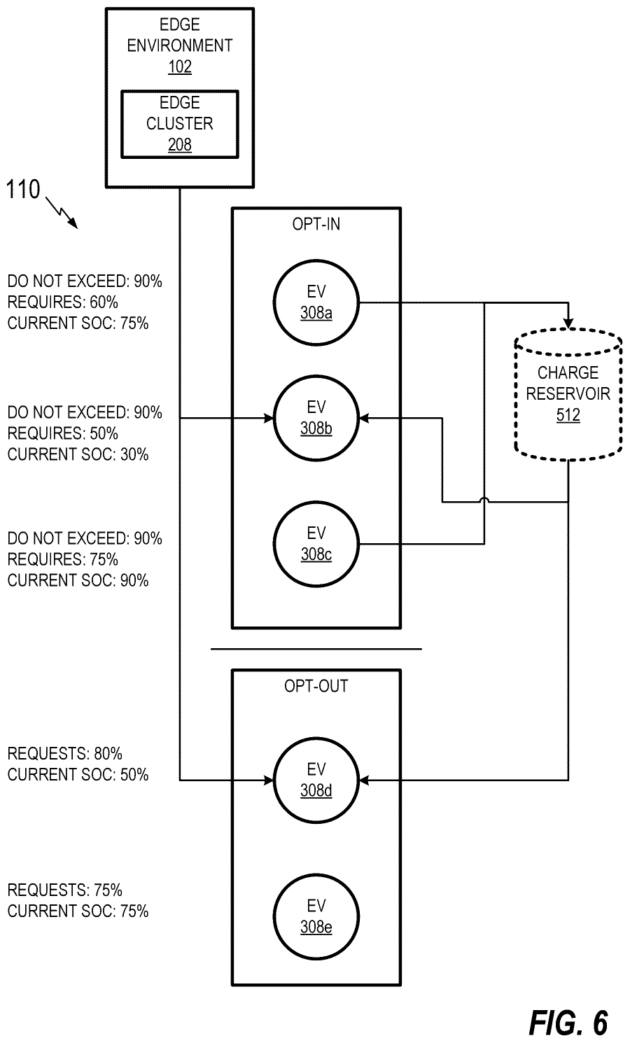

FIG. 6 depicts a configuration of EVs 308 to opt into or opt out of participating in a charge reservoir 512 program, according to embodiments provided herein. A charge reservoir 512 program is an agreement between a user and a site to share power from the user's EV with other EVs. As illustrated, embodiments may be configured to provide a user option (such as via a user interface on a mobile application or via a vehicle interface) for a user to opt into and/or opt out of the charge reservoir 512 functionality. The user interface may additionally provide options for the user to designate a do not exceed value and a minimum charge value. Other options such as whether the user permits the edge environment 102 to charge energy for others may also be provided to the user.

As illustrated in the example of FIG. 6, EVs 308a, 308b, and 308c have opted into the charge reservoir 512 functionality. EVs 308d and 308e have opted out of the charge reservoir 512 functionality. For purposes herein, opting in and opting out may be interpreted to reflect that a user and/or EV 308 is part of (or not part of) the program. Depending on the embodiment, a user and/or EV 308 may default to being subscribed or unsubscribed. Accordingly, in FIG. 6, the EVs 308a, 308b, 308c, 308d, and 308e are plugged into the EVSE 510a, 510b, 501c, 510d, and 510e, respectively. As such, the EVs 308 communicate data back to the edge cluster 208, such as current state of charge, requested and/or desired energy, and time available. The EVs 308a, 308b, 308c may also communicate a maximum charge. A maximum charge may be configured as the maximum amount of charge the EV 308 can accept and/or may be a user-defined level of charge. From this information, the edge cluster 208 may determine that because EVs 308a, 308c are within the range between maximum charge and required charge (or simply below the desired charge), that EVs 308a, 308c can be donor EVs and may send energy to the charge reservoir 512. Because EV 308b is below the desired charge, EV 308b may receive energy from the charge reservoir 512. While EVs 308d, 308e are not part of the charge reservoir 512 program, these EVs can receive charge from the charge reservoir 512, depending on a predetermined strategy being employed by the edge environment 102. As such, because EV 308d needs energy, it may receive such energy from the charge reservoir 512 or from the utility 112d (not shown in FIG. 6).

It will be understood that embodiments provided herein are directed to a charge reservoir 512 at a charging station 112. The charge reservoir 512 may be a virtual or physical component, but in many embodiments provided herein is not part of the electrical grid. Instead many embodiments provided herein utilize the charge reservoir 512 as a supplement, or at certain times, a replacement of the electrical grid. Consequently, while some embodiments may also be configured to communicate some energy back to the grid, the charge reservoir should be interpreted as distinct from the electrical grid.

### Example Process

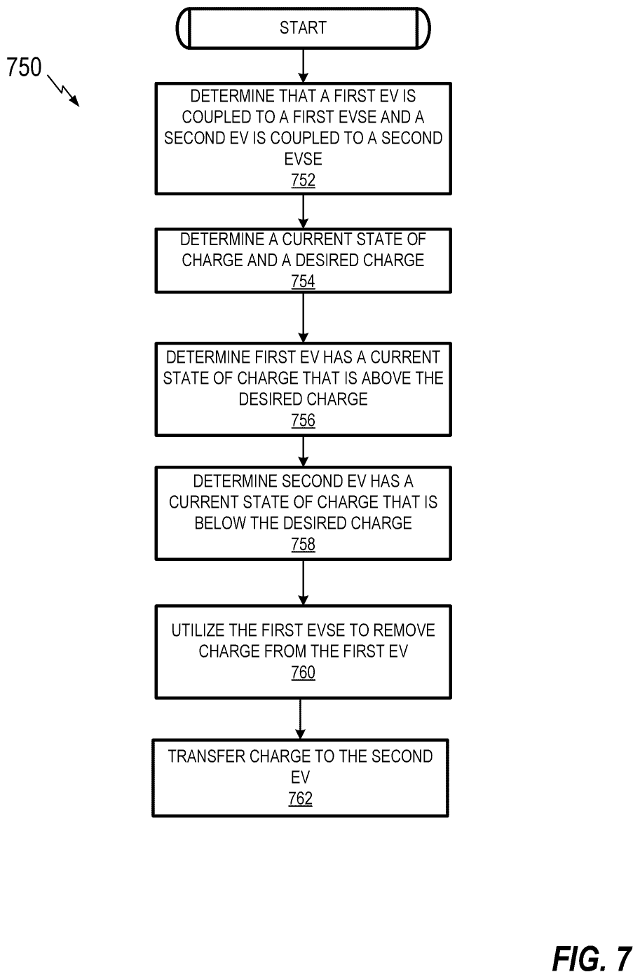

FIG. 7 depicts a flowchart 750 for providing a charge reservoir, according to embodiments provided herein.

As illustrated in block 752, a determination is made that a first EV 308a is coupled to a first EVSE 510a and a second EV 308b is coupled to a second EVSE 510b. This determination may be made based on a triggering of the EVSE 510a communicating energy and/or data with the first EV 308a, via a user input requesting a connection be made, and/or via other mechanism.

In block 754, a determination may be made that a current state of charge and a desired charge for the first EV 308a and the second EV 308b. Specifically, this determination may be made via data being communicated between the EV 308a, the EV 308b, and the respective EVSE 510a, EVSE 510b.

In block 756, a determination may be made that the first EV 308a has a current state of charge that is above the desired charge. The desired state of charge may be determined based on a determination of expected driving before reaching a next charger, based on user input, based on historical usage, and/or based on other criteria.

In block 758, a determination may be made that the second EV 308b has a current state of charge that is below the desired charge.

In block 760, the first EVSE 510a may be utilized to remove charge from the first EV 308a to a charge reservoir 512.

In block 762, the second EVSE 510b may be utilized to transfer charge from the charge reservoir 512 to the second EV 308b until the desired charge for the second EV 308b is met.

It will be understood that embodiments provided herein may be configured to affect physical change to an EV and/or EVSE by altering the location of energy to more effectively accommodate needs of one or more EVs. Additionally, these embodiments cannot be performed by a human because the distribution of energy as provided herein requires knowledge of the current state of an EV, a predicted usage of the EV, as well as other infomraiton and the distribution of energy is time sensitive in that an EV may need a predetermined level of charge by a certain time. These embodiments also improve the technical field of EV energy distribution by reducing required capacity of an EVSE, while still delivering desired energy in a desired timeframe.

Additionally, some embodiments may be configured to allow a first user of the first EV 308a or a second user of a second EV 308b to opt into or out of using the charge reservoir 512. Similarly, some embodiments may be configured to determine that a third EV 308c is coupled to a third EVSE 510c. If the third EV 308c has not opted into the charge reservoir 512, the third EV 308c may be excluded from contributing energy to the charge reservoir 512. Some embodiments may be configured to utilizing load sharing to schedule charging the second EV. Some embodiments may determine a maximum charge for the first EV and the second EV and determine whether the first EV is below the maximum charge.

### Example Clauses

Implementation examples are described in the following numbered clauses:

Clause 1: A method, comprising: determining, by a computing device, that a first electric vehicle (EV) is coupled to a first electric vehicle supply equipment (EVSE) and a second EV is coupled to a second EVSE; determining, by the computing device, a current state of charge and a desired charge for the first EV and the second EV; determining, by the computing device, that the first EV has a current state of charge that is greater than the desired charge; determining, by the computing device, that the second EV has a current state of charge that is less than the desired charge; utilizing, by the computing device, the first EVSE to remove charge from the first EV to a charge reservoir; and utilizing by the computing device, the second EVSE to transfer charge from the charge reservoir to the second EV until the desired charge for the second EV is met.

Clause 2: The method of clause 1, further comprising providing a user interface to at least one of the following: a first user of the first EV or a second user of the second EV to opt into using the charge reservoir.

Clause 3: The method of clauses 1 and/or 2, further comprising determining whether the first user has opted into using the charge reservoir before removing charge from the first EV.

Clause 4: The method of any of clauses 1 through 3, further comprising utilizing load sharing to schedule charging the second EV.

Clause 5: The method of any of clauses 1 through 4, further comprising: determining that a third EV is coupled to a third EVSE; determining that the third EV has not opted into the charge reservoir; and excluding the third EV from contributing energy to the charge reservoir.

Clause 6: The method of any of clauses 1 through 5, further comprising determining a maximum charge for the first EV and the second EV.

Clause 7: The method of any of clauses 1 through 6, further comprising determining whether the first EV is below the maximum charge.

Clause 8: A system, comprising: a charging station that includes a first electric vehicle supply equipment (EVSE) for receiving a first electric vehicle (EV) and a second EVSE for receiving a second EV; and an edge environment that is coupled to the charging station and includes a memory component and a processor, the edge environment including a an edge cluster that, when executed by the processor, causes the system to perform at least the following: determine that the first EV is coupled to a first EVSE and the second EV is coupled to the second EVSE; determine a current state of charge and a desired charge for the first EV and the second EV; determine that the first EV has a current state of charge that is greater than the desired charge; determine that the second EV has a current state of charge that is less than the desired charge; utilize the first EVSE to remove charge from the first EV to a charge reservoir; and utilize the second EVSE to transfer charge from the charge reservoir to the second EV until the desired charge for the second EV is met.

Clause 9: The system of clause 8, wherein the logic further causes the edge environment to provide a user interface to at least one of the following: a first user of the first EV or a second user of the second EV to opt into using the charge reservoir.

Clause 10: The system of clause 8 and/or 9, wherein the logic further causes the edge environment to determine whether the first user has opted into using the charge reservoir before removing charge from the first EV.

Clause 11: The system of any of clauses 8 through 10, wherein the logic further causes the edge environment to utilize load sharing to schedule charging the second EV.

Clause 12: The system of any of clauses 8 through 11, wherein the logic further causes the edge environment to perform at least the following: determine that a third EV is coupled to a third EVSE; determine that the third EV has not opted into the charge reservoir; and excluding the third EV from contributing energy to the charge reservoir.

Clause 13: The system of any of clauses 8 through 12, wherein the logic further causes the edge environment to determine a maximum charge for the first EV and the second EV.

Clause 14: The system of any of clauses 8 through 13, wherein the logic further causes the edge environment to determine whether the first EV is below the maximum charge.

Clause 15: A non-transitory computer-readable storage medium that includes logic, that, when executed by a computing device, causes the computing device to perform at least the following: determine that a first electric vehicle (EV) is coupled to a first electric vehicle supply equipment (EVSE) and a second EV is coupled to a second EVSE; determine a current state of charge and a desired charge for the first EV and the second EV; determine that the first EV has a current state of charge that is greater than the desired charge; determine that the second EV has a current state of charge that is less than the desired charge; utilize the first EVSE to remove charge from the first EV to a charge reservoir; and utilize the second EVSE to transfer charge from the charge reservoir to the second EV until the desired charge for the second EV is met.

Clause 16: The non-transitory computer-readable storage medium of clause 15, wherein the logic further causes the computing device to provide a user interface to at least one of the following: a first user of the first EV or a second user of the second EV to opt into using the charge reservoir.

Clause 17: The non-transitory computer-readable storage medium of clause 15 and/or 16, wherein the logic further causes the computing device to determine whether the first user has opted into using the charge reservoir before removing charge from the first EV.

Clause 18: The non-transitory computer-readable storage medium of any of clauses 15 through 17, wherein the logic further causes the computing device to utilize load sharing to schedule charging the second EV.

Clause 19: The non-transitory computer-readable storage medium of any of clauses 15 through 18, wherein the logic further causes the computing device to perform at least the following:

determine that a third EV is coupled to a third EVSE; determine that the third EV has not opted into the charge reservoir; and excluding the third EV from contributing energy to the charge reservoir.

Clause 20: The non-transitory computer-readable storage medium of any of clauses 15 through 19, wherein the logic further causes the computing device to determine a maximum charge for the first EV and the second EV.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
determining, by a computing device, that a first electric vehicle (EV) is coupled to a first electric vehicle supply equipment (EVSE) and a second EV is coupled to a second EVSE;
determining, by the computing device, a current state of charge and a desired charge for the first EV and the second EV;
determining, by the computing device, that the first EV has a current state of charge that is greater than the desired charge;
determining, by the computing device, that the second EV has a current state of charge that is less than the desired charge;
utilizing, by the computing device, the first EVSE to remove charge from the first EV to a charge reservoir; and
utilizing by the computing device, the second EVSE to transfer charge from the charge reservoir to the second EV until the desired charge for the second EV is met.

2. The method of claim 1, further comprising providing a user interface to at least one of the following: a first user of the first EV or a second user of the second EV to opt into using the charge reservoir.

3. The method of claim 2, further comprising determining whether the first user has opted into using the charge reservoir before removing charge from the first EV.

4. The method of claim 1, further comprising utilizing load sharing to schedule charging the second EV.

5. The method of claim 1, further comprising:
determining that a third EV is coupled to a third EVSE;
determining that the third EV has not opted into the charge reservoir; and
excluding the third EV from contributing energy to the charge reservoir.

6. The method of claim 1, further comprising determining a maximum charge for the first EV and the second EV.

7. The method of claim 6, further comprising determining whether the first EV is below the maximum charge.

8. A system, comprising:
a charging station that includes a first electric vehicle supply equipment (EVSE) for receiving a first electric vehicle (EV) and a second EVSE for receiving a second EV; and
an edge environment that is coupled to the charging station and includes a memory component and a processor, the edge environment including a an edge cluster that, when executed by the processor, causes the system to perform at least the following:
determine that the first EV is coupled to a first EVSE and the second EV is coupled to the second EVSE;
determine a current state of charge and a desired charge for the first EV and the second EV;
determine that the first EV has a current state of charge that is greater than the desired charge;
determine that the second EV has a current state of charge that is less than the desired charge;
utilize the first EVSE to remove charge from the first EV to a charge reservoir; and
utilize the second EVSE to transfer charge from the charge reservoir to the second EV until the desired charge for the second EV is met.

9. The system of claim 8, wherein the logic further causes the edge environment to provide a user interface to at least one of the following: a first user of the first EV or a second user of the second EV to opt into using the charge reservoir.

10. The system of claim 9, wherein the logic further causes the edge environment to determine whether the first user has opted into using the charge reservoir before removing charge from the first EV.

11. The system of claim 8, wherein the logic further causes the edge environment to utilize load sharing to schedule charging the second EV.

12. The system of claim 8, wherein the logic further causes the edge environment to perform at least the following:
determine that a third EV is coupled to a third EVSE;
determine that the third EV has not opted into the charge reservoir; and
excluding the third EV from contributing energy to the charge reservoir.

13. The system of claim 8, wherein the logic further causes the edge environment to determine a maximum charge for the first EV and the second EV.

14. The system of claim 13, wherein the logic further causes the edge environment to determine whether the first EV is below the maximum charge.

15. A non-transitory computer-readable storage medium that includes logic, that, when executed by a computing device, causes the computing device to perform at least the following:
determine that a first electric vehicle (EV) is coupled to a first electric vehicle supply equipment (EVSE) and a second EV is coupled to a second EVSE;
determine a current state of charge and a desired charge for the first EV and the second EV;
determine that the first EV has a current state of charge that is greater than the desired charge;
determine that the second EV has a current state of charge that is less than the desired charge;
utilize the first EVSE to remove charge from the first EV to a charge reservoir; and
utilize the second EVSE to transfer charge from the charge reservoir to the second EV until the desired charge for the second EV is met.

16. The non-transitory computer-readable storage medium of claim 15, wherein the logic further causes the computing device to provide a user interface to at least one of the following: a first user of the first EV or a second user of the second EV to opt into using the charge reservoir.

17. The non-transitory computer-readable storage medium of claim 16, wherein the logic further causes the computing device to determine whether the first user has opted into using the charge reservoir before removing charge from the first EV.

18. The non-transitory computer-readable storage medium of claim 15, wherein the logic further causes the computing device to utilize load sharing to schedule charging the second EV.

19. The non-transitory computer-readable storage medium of claim 15, wherein the logic further causes the computing device to perform at least the following:
determine that a third EV is coupled to a third EVSE;
determine that the third EV has not opted into the charge reservoir; and
excluding the third EV from contributing energy to the charge reservoir.

20. The non-transitory computer-readable storage medium of claim 15, wherein the logic further causes the computing device to determine a maximum charge for the first EV and the second EV.
